(19) United States
(12) Patent Application Publication
(10) Pub. No.: US 2023/0138262 A1
(43) Pub. Date: May 4, 2023

(54) FAST-DISINTEGRATING SOLID HERBICIDE COMPOSITION AND THE USE THEREOF

(71) Applicant: Rotam Agrochem International Company Limited, Chai Wan (HK)

(72) Inventor: James Timothy Bristow, Chai Wan (HK)

(73) Assignee: Rotam Agrochem International Company Limited, Chai Wan (HK)

(21) Appl. No.: 17/517,763

(22) Filed: Nov. 3, 2021

(51) Int. Cl. A01N 43/40; A01N 25/12

(52) U.S. Cl. CPC A01N 43/40; A01N 25/12

(57) ABSTRACT

A solid herbicidal composition comprising a high content of a topramezone herbicide is provided. The solid herbicidal composition further includes alkali metal ions with an amount equivalent to at least 80% of the molar equivalent of the topramezone herbicide. A method of preparing a solid herbicidal composition in the form of dried granules which have fast disintegration performance and a high content of the topramezone herbicide is also provided.

### TECHNICAL FIELD

The present invention relates to a solid herbicidal composition, in particular to a solid preparation composition having fast disintegration performance and with a high content of topramezone, and a preparation method therefor.

### BACKGROUND ART

Topramezone (English common name) with a chemical name [3-(4,5-dihydro-3-isoxazolyl)-4-methylsulfonyl-2-methylbenzene]5-hydroxy-1-methyl-1H-pyrazol-4-yl)methanone is the first pyrazolone benzoate herbicide developed by BASF and is a new type of pyrazolone-based intake transportation herbicide for post-emergence stem and leaf treatment. Topramezone and the preparation thereof are known from WO 98/31681 and WO 99/58509.

The mechanism of action of topramezone is to inhibit 4-hydroxyphenylpyruvate dioxygenase (HPPD) in the biosynthesis of plastoquinone, indirectly affect the synthesis of carotenoids and interfere with the synthesis and function of chloroplasts under light conditions, resulting in serious green fading and albino and tissue necrosis, and plants usually die after 14 days of treatment. Due to the oxidative degradation of chlorophyll, especially, the overground growing zone of sensitive weeds has the most obvious symptoms of toxication. Topramezone is absorbed by sensitive weeds through leaves and roots, and transported both up and down in plants, causing the plants to stop growing quickly. Symptoms of albino toxication appeared in the overground part of the weeds within 2-5 days after application. Growth points, leaves and veins have the most obvious symptoms of toxication. The albino tissues gradually became necrotic, and the entire plant wither to die. Depending on the weather and environment, it would take about 10-15 days from the application to death of weeds. Topramezone is safe to corn. Compared with sensitive weeds, the resistance of corn to topramezone is due to its low sensitivity to target enzymes, less absorption and transportation for topramezone, and faster metabolism. Topramezone can effectively kill annual gramineous and broadleaf weeds and cyperaceae weeds, such as crabgrass, barnyardgrass, setaria, brachiaria, goosegrass, wild millet, pennisetum, cenchrus, cyperus difformis, cyperus iria, amaranth, polygonum, field bindweed, cephalanoplos seyetum, goosefoots, cocklebur, solanum nigrum, abutilon, datura, galeopsis bifida, matricaria, ragweed, wild mustard, wild Carrots, acanthospermum, acanthospermum hispidum, annual mercury, south american beggarweed, emilia sonchifolia, galinsoga, nicandra, dayflower, lindernia and mazus. Topramezone can also effectively and stably control broadleaf weeds that have developed resistance to ALS and triazine herbicides.

WO 2008064988 A discloses the preparation of an aqueous composition comprising a monovalent cation salt of topramezone, which can be combined with fertilizers and is compatible and stable. The content of topramezone disclosed therein is 0.005-500 g/L, preferably 10-300 g/L. However, when the pharmacist prepares the aqueous formulation of the monovalent cation salt of topramezone, it is difficult to formulate an aqueous formulation with the content of topramezone more than 300 g/L, and higher, such as more than 500 g/L due to the limitation by the influence of the water solubility of the monovalent cation salt of topramezone and ambient temperature.

WO 2008015280 A discloses a concentrated solution composition of topramezone and dicamba dissolved in water in the form of alkali metal salt or ammonium salt, and the content of topramezone disclosed therein is 10-100 g/L. It is also difficult to prepare an aqueous products with a high content of topramezone.

WO 2020043470 Al discloses an aqueous composition with a content of topramezone of 0.1%-1%. The content is lower in its special application environment.

At present, the commercialized products of topramezone are mainly liquid preparations, such as “Stellar Star”, i.e., topramezone 50 g/L+dicamba 160 g/L SL; “Armezon”, topramezone 336 g/L SC; “Armezon Pro”, i.e., topramezone 1.12%+dimethenamid-P 56.25% SE, all from BASF. The content of topramezone in these liquid preparations is relatively low. In view of the influence of various economic and environmental factors, it is necessary to prepare high-content pesticide preparation products to reduce the package quantity and transportation cost and the quantity of packaging materials that must be processed after pesticide application.

Experienced pharmacists know that a solid pesticide preparation is an ideal dosage form for preparing a preparation with a high content of pesticide active substances. However, it has been found that a solid preparation with a high content of topramezone, such as a solid preparation with a topramezone content of more than 30%, especially a topramezone content of more than 40%, disintegrate poorly when diluted with water, which brings great inconvenience to users.

Therefore, the object of the present invention is to provide a solid herbicidal composition comprising topramezone, which has a relatively high content of topramezone active substances and has good disintegration performance. In addition, the solid herbicidal composition is economical, environmentally friendly, convenient for transportation and convenient for users to use.

### SUMMARY

It was surprisingly discovered that these and other objectives are achieved by the use of specific molar equivalents of alkali metal ions.

Therefore, the present invention provides a solid herbicidal composition comprising topramezone, which comprises:

(1) at least 35 wt % of a topramezone herbicide;

(2) alkali metal ions with the amount of at least 80% of the molar equivalent of the topramezone herbicide.

### DETAILED DESCRIPTION OF EXAMPLE EMBODIMENTS

The solid herbicidal composition of topramezone according to the present invention comprises at least 35 wt % of topramezone, especially at least 38 wt % of topramezone, particularly at least 40 wt % of topramezone. The preferred amount of topramezone is 35-85 wt % of the solid herbicidal composition, and the particularly preferred amount of topramezone is 40-75 wt % of the solid herbicidal composition. The alkali metal ions in the present invention are monovalent cations of metal elements of group IA in the periodic table. Preferred alkali metal ions are monovalent cations of lithium, sodium, and potassium. These alkali metal ions are derived from hydroxides or alkaline salts comprising alkali metal ions. The “hydroxides” refer to lithium hydroxide, sodium hydroxide and potassium hydroxide; The term “alkaline salts” refer to those salts that are alkaline when dissolved in water, such as lithium carbonate, lithium bicarbonate, lithium phosphate, lithium monohydrogen phosphate, lithium tripolyphosphate, sodium carbonate, sodium bicarbonate, sodium phosphate, sodium monohydrogen phosphate, sodium tripolyphosphate, potassium carbonate, potassium bicarbonate, potassium phosphate, potassium monohydrogen phosphate, potassium tripolyphosphate and hydrates thereof. These hydroxides or alkaline salts are preferably sodium hydroxide, potassium hydroxide, sodium carbonate, sodium phosphate, potassium carbonate and potassium phosphate, and particularly preferably sodium hydroxide, potassium hydroxide, lithium hydroxide, sodium phosphate, potassium phosphate and lithium phosphate. According to example embodiments, the alkali metal ions are derived from sodium hydroxide, potassium hydroxide, sodium phosphate, lithium hydroxide, or sodium lauryl sulfate.

The “alkaline salts” can also be salts whose aqueous solutions are alkaline, for example, organic salts of lithium, sodium and potassium, or polymer salts, or alkali metal salts of alcohol, such as sodium methoxide, sodium ethoxide, potassium ethoxide, lithium tert-butoxide, etc.; alkali metal salts, such as butyl lithium, sodium alkyl sulfonate, potassium alkyl sulfonate, sodium akylbenzene sulfonate; polymer alkali metal salts, such as sodium lignosulfonate, sodium naphthalenesulfonate, sodium or potassium polycarboxylate, etc.; these salts are also included in the present invention, especially those organic salts or polymer salts whose 1% aqueous solution has a pH value of 8.5 or higher, preferably those organic salts or polymer salts with a pH value of 9-14.

The weight of the alkali metal ions is at least 80% or more of the molar equivalent of the topramezone herbicide, especially 90% or more of the molar equivalent, especially 100% or more of the molar equivalent; it is preferable to use an amount of 80%-150% of the molar equivalent of topramezone, and it is particularly preferable to use an amount of 100%-120% of the molar equivalent of topramezone.

In addition, the solid herbicidal composition may also comprise functional surfactants commonly used in crop protection products. Suitable functional surfactants are selected from dispersants, wetting agents, penetrants, bactericides, defoamers, stabilizers, inert carriers, colorants, binders, and the like. According to example embodiments, the solid herbicidal composition includes organosilicone defoamer.

Suitable surfactants are surface-active compounds, such as anionic, cationic, nonionic and amphoteric surfactants, block polymers, polyelectrolytes, and mixtures thereof. Such surfactants can be used as emulsifiers, dispersants, solubilizers, wetting agents, penetrants, protective colloids or auxiliary agents.

Suitable anionic surfactants are alkali metal salts, alkaline earth metal salts or ammonium salts of sulfonic acid, sulfuric acid, phosphoric acid and carboxylic acid, and mixtures thereof. Examples of sulfonates are alkyl aryl sulfonates, diphenyl sulfonates, α-olefin sulfonates, lignosulfonates, sulfonates of fatty acids and oils, sulfonates of ethoxylated alkylphenols, sulfonates of alkoxylated arylphenols, sulfonates of condensed naphthalene, sulfonates of dodecyl- and tridecyl-benzene, sulfonates of naphthalene and alkylnaphthalene, sulfosuccinates or sulfosuccinamate. Examples of sulfates are the sulfates of fatty acids and oils, the sulfates of ethoxylated alkylphenols, the sulfates of alcohols, the sulfates of ethoxylated alcohols, or the sulfates of fatty acid esters. Examples of phosphates are phosphate esters. Examples of carboxylates are alkyl carboxylates and carboxylated alcohol or alkylphenol ethoxylates. The preferred anionic surfactants are sulfates and sulfonates, for example naphthalenesulfonate formaldehyde polycondensate and lignosulfonate.

Suitable nonionic surfactants are alkoxylates, N-substituted fatty acid amides, amine oxides, esters, sugar-based surfactants, polymeric surfactants and mixtures thereof. Examples of alkoxylates are compounds of alcohols, alkylphenols, amines, amides, arylphenols, fatty acids or fatty acid esters that have been alkoxylated with 1-50 equivalents. Ethylene oxide and/or propylene oxide can be used for alkoxylation, preferably ethylene oxide. Examples of N-substituted fatty acid amides are fatty acid glucosamides or fatty acid alkanolamides. Examples of esters are fatty acid esters, glycerides or monoglycerides. Examples of sugar-based surfactants are sorbitan, ethoxylated sorbitan, sucrose and glucose esters or alkyl polyglucosides. Examples of polymeric surfactants are homopolymers or copolymers of vinylpyrrolidone, vinyl alcohol or vinyl acetate. The preferred nonionic surfactants are alkoxylates. Nonionic surfactants such as alkoxylates can also be used as auxiliary agents.

Suitable cationic surfactants are quaternary surfactants, such as quaternary ammonium compounds having 1 or 2 hydrophobic groups, or salts of long-chain primary amines.

Suitable amphoteric surfactants are alkyl betaines and imidazolines.

Suitable block polymers are A-B or A-B-A type block polymers comprising blocks of polyoxyethylene and polyoxypropylene, or A-B-C type block polymers comprising alkanol, polyoxyethylene and polyoxypropylene.

Suitable polyelectrolytes are polyacids or polybases, preferably polyacids. Examples of polybases are polyvinylamine or polyethyleneamine. Examples of polyacids are acrylic copolymers or AMPS (2-acrylamido-2-methylpropanesulfonic acid) copolymers. Preferably, the polyelectrolytes are copolymers comprising, in polymerized form, amides comprising at least one monomer selected from N-vinyl lactam, N-C₁-C₆alkyl acrylamide and N,N-diC₁-C₆alkyl acrylamide; poly(C₂₋₆alkyleneglycol)(methyl)acrylate and/or mono-C₁₋₂₂alkyl-terminated poly(C₂₋₆alkyleneglycol)(methyl)acrylate; C₁-C₈alkyl(methyl)acrylate; and (methyl)acrylic acid. Preferably, the polyelectrolytes are copolymers comprising, in polymerized form, amides comprising at least one monomer selected from N-vinyl lactam, mono-C₁₋₂₂alkyl-terminated poly(C₂₋₆alkyleneglycol) (methyl)acrylate; C1-C₈alkyl(methyl)acrylate; and (methyl)acrylic acid. In another preferred form, the polyelectrolytes are copolymers comprising, in polymerized form, 25-85 wt % of amides comprising at least one monomer selected from N-vinyl lactam, 1-40 wt % of mono-C₁₋₂₂alkyl-terminated poly(C₂₋₆alkyleneglycol) (methyl)acrylate; 5-50 wt % of C₁-C₈alkyl(methyl)acrylate; and up to 15 wt % of (methyl)acrylic acid, wherein the sum of the individual monomers is equal to 100%. In another preferred form, the polyelectrolytes are copolymers comprising, in polymerized form, 30-85 wt % of amides comprising at least one monomer selected from N-vinyl lactam, 5-20 wt % of mono-C₁₋₂₂alkyl-terminated poly(C₂₋₆alkyleneglycol) (methyl)acrylate; 8-35 wt % of C₁-C₈alkyl(methyl)acrylate; and 0.5-10 wt % of (methyl)acrylic acid, wherein the sum of the individual monomers is equal to 100%. In another preferred form, the polyelectrolytes are copolymers comprising, in polymerized form, at least one olefinic unsaturated monomer comprising a sulfonic acid group, at least one monomer selected from C₁-C₄alkyl(methyl)acrylate and at least one monomer selected from C₆-C₂₂alkyl(methyl)acrylate. In another preferred form, the polyelectrolytes are copolymers comprising, in polymerized form, 5-50 wt % of at least one olefinic unsaturated monomer comprising a sulfonic acid group, 20-70 wt % of at least one monomer selected from C₁-C₄alkyl(methyl)acrylate and 5-30 wt % of at least one monomer selected from C₆-C₂₂alkyl(methyl)acrylate, based on total weight of the monomers. The concentrate may comprise 0.5-40 wt %, preferably 2-30 wt %, especially 5-25 wt % of polyelectrolytes (e.g., polyacid such as acrylic copolymer or AMPS copolymer).

Suitable auxiliary agents are compounds that have negligible pesticide activity or even have no pesticide activity and improve the biological performance of a pesticide against a target. Examples are surfactants, mineral or vegetable oils and other auxiliaries.

Suitable bactericides are bronopol and isothiazolinone derivatives such as alkyl isothiazolinones and benzisothiazolinones.

Suitable defoamers are one or more of silicone oil, silicone compounds, C₁₀₋₂₀ saturated fatty acid compounds, and C₈₋₁₀ fatty alcohol compounds.

Suitable stabilizers are those that can prevent the active ingredients from decomposing during storage, such as BHT or resorcinol.

Suitable inert carriers are plant-based powders (e.g., soy flour, starch, grain flour, wood flour, bark flour, sawdust, walnut shell flour, bran, cellulose powder, coconut husk, granules from corn cob and tobacco stem, residues after extracting plant extracts, etc.), paper, sawdust, synthetic polymer of crushed synthetic resin and the like, clays (such as kaolin, calcinated kaolin, bentonite, acidic china clay, etc.), talcum powder, silica (such as diatomite, silica sand, mica, hydrous silicate, calcium silicate), activated carbon, white carbon black, natural minerals (pumice, attapulgite and zeolite, etc.), calcined diatomite, sand, plastic media and the like (such as polyethylene, polypropylene, polyvinylidene chloride, etc.), inorganic mineral powders (such as potassium chloride, calcium carbonate, and calcium phosphate), chemical fertilizers (such as ammonium sulfate, ammonium phosphate, urea, and ammonium chloride), and soil fertilizers. These substances can be used alone or in a mixture of two or more of them.

Suitable colorants (for example red, blue or green colorants) are low water-soluble pigments and water-soluble dyes. Examples are inorganic colorants (such as iron oxide, titanium oxide, ferric hexacyanoferrate) and organic colorants (such as alizarin colorants, azo colorants, and phthalocyanine colorants).

Suitable binders are one or more of polyvinylpyrrolidone, methylcellulose, polyvinyl alcohol, polyethylene glycol, and water.

The solid herbicidal composition comprising topramezone according to the present invention may also comprise other herbicidal active ingredients, including but not limited to 2,4-D, acetochlor, acifluorfen, aclonifen, alachlor, allidochlor, alloxydim, ametryn, amicarbazone, amidosulfuron, anilofos, atraton, atrazine, azafenidin, azimsulfuron, aziprotryne, barban, beflubutamid, benazolin, benfluralin, benfuresate, bensulfuron, bentazone, benzadox, benzfendizone, benzipram, benzobicyclon, benzofenap, benzoylprop, benzthiazuron, bifenox, bilanafos, bispyribac, bromacil, bromobutide, bromoxynil, brompyrazon, butachlor, butafenacil, butamifos, butenachlor, buthidazole, buthiuron, butralin, butroxydim, cacodylic acid, cafenstrole, carfentrazone, chlomethoxyfen, chloramben, chloranocryl, chlorazine, chlorbromuron, chlorbufam, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorthal, chlorthiamid, cinidon-ethyl, cinmethylin, cinosulfuron, cisanilide, clethodim, cliodinate, clomazone, cloransulam, CMA, copper sulfate, CPMF, CPPC, credazine, cresol, cumyluron, cyanatryn, cyanazine, cycloate, cyclosulfamuron, cycloxydim, cycluron, cyperquat, cyprazine, cyprazole, cypromid, daimuron, dalapon, dazomet, delachlor, desmedipham, desmetryn, di-allate, dichlobenil, dichloralurea, dichlormate, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, eglinazine, endothal, epronaz, erbon, esprocarb, ethalfluralin, ethidimuron, ethiolate, ethofumesate, ethoxyfen, ethoxysulfuron, etinofen, etobenzanid, fentrazamide, fenuron, flamprop, flamprop-methyl, flazasulfuron, florasulam, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, flurtamone, fluthiacet, fomesafen, foramsulfuron, fosamine, furyloxyfen, glufosinate, glufosinate-P, glyphosate, halauxifen, halosafen, halosulfuron, haloxydine, hexaflurate, hexazinone, imazamethabenz, imazamox, imazapic, imazapyr, imazaquin, imazethapyr, imazosulfuron, indanofan, indaziflam, iodosulfuron, ioxynil, ipazine, ipfencarbazone, iprymidam, isocarbamid, isocil, isomethiozin, isonoruron, isopropalin, isoproturon, isouron, isoxaben, isoxaflutole, karbutilate, lactofen, lenacil, linuron, medinoterb, mefenacet, mefluidide, mesoprazine, mesosulfuron, mesotrione, metamitron, metazachlor, metazosulfuron, mefflurazon, methabenzthiazuron, methalpropalin, methazole, methiuron, methometon, methoprotryne, methyldymron, metobenzuron, metobromuron, metolachlor, metosulam, metoxuron, metribuzin, molinate, monalide, monisouron, monolinuron, monuron, morfamquat, naproanilide, napropamide, naptalam, neburon, nicosulfuron, nipyraclofen, nitralin, nitrofen, nitrofluorfen, norflurazon, noruron, orbencarb, orthosulfamuron, oryzalin, oxadiargyl, oxadiazon, oxapyrazon, oxasulfuron, oxaziclomefone, oxyfluorfen, parafluron, pebulate, pendimethalin, penoxsulam, pentanochlor, pentoxazone, perfluidone, pethoxamid, phenisopham, phenmedipham, phenobenzuron, picolinafen, pinoxaden, piperophos, pretilachlor, primisulfuron, procyazine, prodiamine, profluazol, profluralin, profoxydim, proglinazine, prometon, prometryn, propachlor, propanil, propazine, propham, propisochlor, propoxycarbazone, propyrisulfuron, propyzamide, prosulfalin, prosulfocarb, prosulfuron, proxan, prynachlor, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, rhodethanil, rimsulfuron, saflufenacil, S-metolachlor, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiocarbazil, tralkoxydim, triafamone, tri-allate, triasulfuron, triaziflam, tribenuron, tricamba, triclopyr, tridiphane, trietazine, trifloxysulfuron, trifluralin, triflusulfuron, trifopsime, trihydroxytriazine, trimeturon, tripropindan, tritac, tritosulfuron, vernolate and xylachlor.

Another object of the present invention is to provide a method for preparing a composition having fast disintegration performance and with a high content of a topramezone herbicide, the method comprises the following steps:

a) preparation of an aqueous mixture comprising

(I) appropriate amount of water;

(II) 35-80 wt % of the topramezone herbicide on moisture-free basis;

(III) hydroxides or alkaline salts of alkali metals with an amount of 80%-150% of the molar equivalent of topramezone; and

(IV) 0-70 wt % of one or more inert carriers and functional surfactants on moisture-free basis;

the sum of the weight percentages of all components in the mixture is 100% on moisture-free basis;

(b) Granulation;

The aqueous mixture prepared in (a) is dried into a paste and extruded into granules or the aqueous mixture prepared in (a) is sprayed directly into granules.

In the preparation method of the present invention, the sum of the total weight percentages of all additives is 100% (except for water). The molar equivalent of the hydroxides or alkaline salts of the alkali metals depends on the molar equivalent of topramezone, preferably is 90%-130% of the molar equivalent of topramezone, particularly preferably is 100%-120% of the molar equivalent of topramezone. The hydroxides or alkaline salts of the alkali metals are preferably lithium hydroxide, potassium hydroxide or sodium hydroxide, suitable inorganic salts, organic salts or polymer salts of lithium, sodium, potassium (which are consistent with the above description and will not be repeated) are also optional.

The preparation method of the present invention also comprises a necessary grinding or sanding process, so that at least 90% of the granules have an average granule size less than 30 microns, more preferably less than 20 microns, and most preferably less than 10 microns.

The preparation method of the present invention also comprises the necessary drying for granules, so that the moisture content of the granules after drying is less than 3%, preferably less than 1.5%.

The solid herbicidal composition and preparation method of the present invention can obtain a solid preparation with a high content of topramezone, solve the technical problem of poor disintegration performance of the existing solid preparation of topramezone, are convenient for users to use and reduce packaging and transportation costs.

### EXAMPLES

### Example 1

### 1. Preparation of an Aqueous Mixture Containing Topramezone;

400 g of topramezone was dispersed in 800 g of water, 27.9 g of sodium hydroxide (about 110% of the molar equivalent of topramezone) was added and stirred evenly, then 30 g of naphthalenesulfonate formaldehyde polycondensate (trade name: MORWET D-425, from Nouryon), 10 g of organosilicone defoamer (trade name: SAG 1572, from Momentive), 20 g of white carbon black (trade name: SIPERNAT 622S, from Evonik) and 512.1 g of lactose were added. After stirring evenly, the wet grinding operation was performed with a sand mill (Dynomill®) using glass beads with 0.8-1.2 mm diameter to obtain an aqueous mixture containing topramezone, in which the granule size of the dispersed granules was D90: 8-9 um.

### 2. Granulation

The aqueous mixture containing topramezone in the above step 1 was dried to make a paste with a water content of about 10%, and then the paste was extruded into granules through a 1.00 mm mold; The wet granules were dried in a vacuum oven at 70° C., and then sieved through a 0.71-3 mm sieve to obtain product granules.

### Example 2

### 1. Preparation of an Aqueous Mixture Containing Topramezone;

500 g of topramezone was dispersed in 800 g of water, 81.0 g of potassium hydroxide (about 105% of the molar equivalent of topramezone) was added and stirred evenly, then 20 g of naphthalenesulfonate formaldehyde polycondensate (trade name: MORWET D-425, from Nouryon), 15 g of fatty alcohol polyoxyethylene ether (trade name: GENAPOL T 250 p, from Clariant), 10 g of organosilicone defoamer (trade name: SAG 1572, from Momentive), 15 g of white carbon black (trade name: SIPERNAT 622S, from Evonik) and 359 g of aluminium-magnesium silicate were added. After stirring evenly, the wet grinding operation was performed with a sand mill (Dynomill®) using glass beads with 0.8-1.2 mm diameter to obtain an aqueous mixture containing topramezone, in which the granule size of the dispersed granules was D90: 8-9 um.

### 2. Granulation

The aqueous mixture containing topramezone in the above step 1 was dried to make a paste with a water content of about 10%, and then the paste was extruded into granules through a 1.00 mm mold; The wet granules were dried in a vacuum oven at 70° C., and then sieved through a 0.71-3 mm sieve to obtain product granules.

### Example 3

### 1. Preparation of an Aqueous Mixture Containing Topramezone;

650 g of topramezone was dispersed in 800 g of water, 112.6 g of sodium phosphate (about 115% of the molar equivalent of topramezone) was added and stirred evenly, then 20 g of lignosulfonate (trade name: Ufoxane 3A, from Borregaard), 10 g of organosilicone defoamer (trade name: SAG 1572, from Momentive), 15 g of white carbon black (trade name: SIPERNAT 622S, from Evonik) and 192.4 g of ammonium sulfate were added. After stirring evenly, the wet grinding operation was performed with a sand mill (Dynomill®) using glass beads with 0.8-1.2 mm diameter to obtain an aqueous mixture containing topramezone, in which the granule size of the dispersed granules was D90: 8-9 um.

### 2. Granulation

The aqueous mixture containing topramezone in the above step 1 was dried to make a paste with a water content of about 10%, and then the paste was extruded into granules through a 1.00 mm mold; The wet granules were dried in a vacuum oven at 70° C., and then sieved through a 0.71-3 mm sieve to obtain product granules.

### Example 4

### 1. Preparation of an Aqueous Mixture Containing Topramezone;

800 g of topramezone was dispersed in 800 g of water, 52.9 g of lithium hydroxide (about 100% of the molar equivalent of topramezone) was added and stirred evenly, then 25 g of methacrylic acid copolymer (trade name: Atlox, from Croda), 10 g of organosilicone defoamer (trade name: SAG 1572, from Momentive), 20 g of white carbon black (trade name: SIPERNAT 622S, from Evonik) and 92.1 g of calcined kaolin were added. After stirring evenly, the wet grinding operation was performed with a sand mill (Dynomill®) using glass beads with 0.8-1.2 mm diameter to obtain an aqueous mixture containing topramezone, in which the granule size of the dispersed granules was D90: 8-9 um.

### 2. Granulation

The spray granulation method was used to directly granulate to obtain product granules.

### Example 5

### 1. Preparation of an Aqueous Mixture Containing Topramezone;

350 g of topramezone was dispersed in 800 g of water, 249.9 g of sodium lauryl sulfate (about 90% of the molar equivalent of topramezone) was added and stirred evenly, then 20 g of naphthalenesulfonate formaldehyde polycondensate (trade name: MORWET D-425, from Nouryon), 10 g of organosilicone defoamer (trade name: SAG 1572, from Momentive), 15 g of white carbon black (trade name: SIPERNAT 622S, from Evonik) and 355.1 g of diatomite were added. After stirring evenly, the wet grinding operation was performed with a sand mill (Dynomill®) using glass beads with 0.8-1.2 mm diameter to obtain an aqueous mixture containing topramezone, in which the granule size of the dispersed granules was D90: 8-9 um.

### 2. Granulation

The aqueous mixture containing topramezone in the above step 1 was dried to make a paste with a water content of about 10%, and then the paste was extruded into granules through a 1.00 mm mold; The wet granules were dried in a vacuum oven at 70° C., and then sieved through a 0.71-3 mm sieve to obtain product granules.

### Comparative Example 1

27.9 g of the sodium hydroxide in Example 1 was removed, and the amount of lactose was adjusted from 512.1 g to 540 g; except for these, the same method as in Example 1 was used for manufacturing to obtain comparative product granules.

### Comparative Example 2

81.0 g of the potassium hydroxide in Example 2 was removed, and the amount of aluminium-magnesium silicate was adjusted from 359 g to 440 g; except for these, the same method as in Example 2 was used for manufacturing to obtain comparative product granules.

### Comparative Example 3

112.6 g of the sodium phosphate in Example 3 was removed, and the amount of ammonium sulfate was adjusted from 192.4 g to 305 g; except for these, the same method as in Example 3 was used for manufacturing to obtain comparative product granules.

### Comparative Example 4

52.9 g of the lithium hydroxide in Example 4 was removed, and the amount of calcined kaolin was adjusted from 92.1 g to 145 g; except for these, the same method as in Example 4 was used for manufacturing to obtain comparative product granules.

### Comparative Example 5

249.9 g of the sodium lauryl sulfate in Example 5 was removed, and the amount of diatomite was adjusted from 355.1 g to 605 g; except for these, the same method as in Example 5 was used for manufacturing to obtain comparative product granules.

### Comparative Example 6

400 g of topramezone, 30 g of naphthalenesulfonate formaldehyde polycondensate (trade name: MORWET D-425, from Nouryon), 10 g of organosilicone defoamer (trade name: SAG 1572, from Momentive), 20 g of white carbon black (trade name: SIPERNAT 622S, from Evonik) and 540 g of lactose were mixed evenly; a jet mill was used to pulverize granules to obtain a powder with a granule size D90 of 8-9 um; water (8%-10%) was added to knead the powder into a paste, and the paste was extruded into granules through a 1.00 mm mold; and the wet granules were dried in a vacuum oven at 70° C., and then sieved through a 0.71-3 mm sieve to obtain comparative product granules.

### Disintegration Test

### 1. Experimental Method

250 ml of standard hard water was added into a 250 ml graduated cylinder, and then 1.0 product granules were added. When all the granules reached the bottom of the graduated cylinder, the graduated cylinder was turned upside down on the same plane, and the number of inversions required for the granules to completely disintegrate was observed and recorded.

### 2. The Experimental Results are as Shown in Table 1:

TABLE 1

| Sample | Number of inversions (times) |
|---|---|
| Example 1 | 18 |
| Example 2 | 20 |
| Example 3 | 19 |
| Example 4 | 12 |
| Example 5 | 17 |
| Comparative example 1 | 52 |
| Comparative example 2 | 55 |
| Comparative example 3 | 58 |
| Comparative example 4 | 65 |
| Comparative example 5 | 61 |
| Comparative example 6 | 70 |

The results in Table 1 show that product granules with a high content of topramezone provided by the present invention have a rapid disintegration effect, and basically all the product granules are completely disintegrated and dispersed within 20 inversions. The disintegration time of the product granules provided by the present invention is shortened by more than half of that of the product granules in comparative examples of the present invention.

1. A solid herbicidal composition comprising:
at least 35 wt % of a topramezone herbicide; and
alkali metal ions in an amount of at least 80% of the molar equivalent of the topramezone herbicide.

2. The solid herbicidal composition according to claim 1, wherein the solid herbicidal composition comprises at least 40 wt % of the topramezone herbicide.

3. The solid herbicidal composition according to claim 1, wherein the solid herbicidal composition comprises at least 40-80 wt % of the topramezone herbicide.

4. The solid herbicidal composition according to claim 1, wherein the alkali metal ions comprise ions selected from the group consisting of: lithium ions, sodium ions, and potassium ions, and mixtures thereof.

5. The solid herbicidal composition according to claim 4, wherein the lithium, sodium, and potassium ions are derived from hydroxides or alkaline salts containing lithium, sodium, and/or potassium.

6. The solid herbicidal composition according to claim 5, wherein the hydroxides or alkaline salts containing lithium, sodium, and potassium are selected from the group consisting of: lithium carbonate, sodium carbonate, potassium carbonate, lithium phosphate, sodium phosphate, potassium phosphate, lithium hydroxide, sodium hydroxide, and potassium hydroxide.

7. The solid herbicidal composition according to claim 6, wherein the hydroxides or alkaline salts containing lithium, sodium, and potassium are selected from the group consisting of: lithium hydroxide, sodium hydroxide, and potassium hydroxide.

8. The solid herbicidal composition according to claim 1, wherein the amount of the alkali metals is an amount which is at least 90% of the molar equivalent of the topramezone herbicide.

9. The solid herbicidal composition according to claim 8, wherein the amount of the alkali metals is an amount which is 100%-120% of the molar equivalent of the topramezone herbicide.

10. The solid herbicidal composition according to claim 1, further comprising one or more functional surfactants.

11. The solid herbicidal composition according to claim 1, wherein the alkali metal ions are derived from sodium hydroxide; and further including naphthalenesulfonate formaldehyde polycondensate, organosilicone defoamer, white carbon black, and lactose.

12. The solid herbicidal composition according to claim 1, wherein the alkali metal ions are derived from potassium hydroxide; and further including naphthalenesulfonate formaldehyde polycondensate, fatty alcohol polyoxyethylene ether, organosilicone defoamer, white carbon black, and aluminium-magnesium silicate.

13. The solid herbicidal composition according to claim 1, wherein the alkali metal ions are derived from sodium phosphate; and further including lignosulfonate, organosilicone defoamer, white carbon black, and ammonium sulfate.

14. The solid herbicidal composition according to claim 1, wherein the alkali metal ions are derived from lithium hydroxide; and further including methacrylic acid copolymer, organosilicone defoamer, white carbon black, and calcined kaolin.

15. The solid herbicidal composition according to claim 1, wherein the alkali metal ions are derived from sodium lauryl sulfate; and further including naphthalenesulfonate formaldehyde polycondensate, organosilicone defoamer, white carbon black, and diatomite.

16. A method for preparing a solid herbicidal composition, comprising the steps of:
(a) preparation of an aqueous mixture comprising:
(I) water;
(II) 35-80 wt % of a topramezone herbicide on a moisture-free basis;
(III) hydroxides or alkaline salts of alkali metals in an amount of 80%-150% of the molar equivalent of topramezone; and
(IV) 0-70 wt % of one or more inert carriers and functional surfactants on a moisture-free basis;
wherein the sum of the weight percentages of all components in the mixture is 100% on moisture-free basis;
(b) granulation, comprising:
drying the aqueous mixture prepared in step (a) into a paste and extruding the paste into granules; or
spraying the aqueous mixture prepared in step (a) directly into granules.

17. The method according to claim 16, wherein the amount of the hydroxides or alkaline salts of alkali metals is an amount which is 100%-120% of the molar equivalent of the topramezone herbicide.

18. The method according to claim 16, wherein the hydroxides or alkaline salts of alkali metals are selected from the group consisting of: lithium hydroxide, sodium hydroxide, potassium hydroxide, lithium carbonate, sodium carbonate, potassium carbonate, lithium phosphate, sodium phosphate, and potassium phosphate.

19. The method according to claim 16, further comprising grinding or sanding the dried granules.

20. The method according to claim 16, further comprising sieving the dried granules.
